(19) United States
(12) Patent Application Publication
(10) Pub. No.: US 2023/0253198 A1
(43) Pub. Date: Aug. 10, 2023

(54) SYSTEMS AND METHODS FOR MASS SPECTROMETRY

(71) Applicant: THE BOARD OF TRUSTEES OF WESTERN MICHICAN UNIVERSITY, Kalamazoo, MI (US)

(72) Inventors: Andre R. Venter, Kalamazoo, MI (US); Roshan Javanshad, Kalamazoo, MI (US)

(21) Appl. No.: 18/098,471

(22) Filed: Jan. 18, 2023

Related U.S. Application Data
(60) Provisional application No. 63/306,350, filed on Feb. 3, 2022.

(51) Int. Cl. H01J 49/16; H01J 49/04

(52) U.S. Cl. CPC H01J 49/167; H01J 49/045

(57) ABSTRACT

A mass spectrometry device and process may include the use of helium as a nebulizing gas to provide increased signal strength in mass spectrum results. This may be implemented in, for example, ESI-based and/or DESI-based systems and/or processes. The process may be implemented utilizing a unique ionization source and, optionally, other unique components. One or more process parameters may be adjusted to provide increased signal intensity in mass spectrum results.

### CROSS-REFERENCE TO RELATED APPLICATION

This application claims the benefit under 35 U.S.C. § 119(e) to U.S. Provisional Patent Application No. 63/306,350, filed Feb. 3, 2022, entitled “SYSTEMS AND METHOD FOR MASS SPECTROMETRY,” which is incorporated herein by reference in its entirety.

### GOVERNMENT LICENSE RIGHTS

This invention was made with government support under grant number CHE 2003379 (2020-2021) awarded by the United States National Science Foundation. The government has certain rights in the invention.

### TECHNOLOGICAL FIELD

The disclosure relates to sampling and ionization of chemical substances for mass spectrometric analysis.

### BACKGROUND

Mass spectrometry may be used to measure the mass-to-charge ratio of ions, resulting in a mass spectrum plot of intensity (ion signal) as a function of the mass-to-charge ratio. In a typical mass spectrometry process, sample components are ionized through one of many processes, causing some molecules or atoms to carry either positive, or negative charges through the loss of an electron, the addition of protons or other cationization or anionizing agents, which may be separated according to their mass-to-charge ratio by, for example, causing the ions to pass through an electric or magnetic field which causes ions having the same mass-to-charge ratio to deflect equally, thereby grouping the ions by mass-to-charge ratio. The ions may be detected by an electron multiplier or other suitable device to permit generation of a mass spectrum plot. Atoms or molecules in the sample can be identified by correlating the results with known atoms or molecules.

In ambient ionization mass spectrometry (AIMS), ions are formed in an ion source outside of the mass spectrometer with little or no sample preparation or separation. Ions can be formed by extraction into charged electrospray droplets, thermally desorbed and ionized by chemical ionization, or laser desorbed or ablated before they enter the mass spectrometer.

Ionization may involve electrospray ionization (ESI), atmospheric pressure chemical ionization (APCI) and direct ionization (e.g. Penning Ionization).

Liquid extraction-based methods, such as Desorption Electrospray Ionization (DESI), may utilize spray solvent extraction and subsequent electrospray ionization to detect molecules from a surface. Sample analysis in DESI may happen via a droplet pickup mechanism involving one or more of the following: (1) formation of a desorption spray plume (primary droplets) by applying direct (DC) voltage to the desorption solvent; (2) formation of a micro-localized solvent (liquid) layer on the sample surface; (3) dissolution/extraction of the analyte into the liquid layer; (4) release of analyte-containing droplets (“secondary” or “progeny” droplets) from the liquid layer by pneumatically accelerated primary droplets; and finally, (5) formation of gas-phase analyte ions from the charged secondary droplets.

### SUMMARY

An aspect of the present disclosure comprises a Helium-Assisted Desorption and Ionization (“HADI”) mass spectrometry device and process, which may include the use of helium as a nebulizing gas to produce a combined electrospray and plasma. This may be implemented in, for example, ESI-based and/or DESI-based techniques/processes. As discussed in more detail below, utilizing helium (He) as a nebulizing gas may provide significant improvements in signal intensity (e.g. in the mass spectrum) for a wide variety of molecules, from small, polar compounds such as xanthine alkaloids to moderately non-polar compounds such as steroids and lipids, while also permitting detection of large, highly polar molecules such as proteins. Solution-phase additives, such as ammonium bicarbonate and formic acid, can be used in combination with helium (He) if required. These additives may provide additional improvement with regards to analysis of different compounds. As discussed in more detail below, a method according to an aspect of the present disclosure may be implemented by modifying the ionization source and, optionally, other hardware.

A method and apparatus according to an aspect of the present disclosure may provide improvements to both ESI-based and DESI-based processes by using helium as the nebulizing gas and adjusting other parameters of the system and/or process. Utilizing He as a nebulizing gas as described herein provides significant improvement in signal intensity for a wide variety of molecules, from small, polar compounds such as xanthine alkaloids to moderately nonpolar compounds such as steroids and lipids. Large highly polar molecules such as proteins are still present as multiply charged ions. Solution-phase additives, such as, for example, ammonium bicarbonate and formic acid, can be used in combination with He as needed. These additives may provide additional improvement in analysis especially in connection with less-polar compounds that may not ionize well by ESI (e.g. hydrocortisone).

A method according to an aspect of the present disclosure may utilize an electrosonic spray ionization source (ESSI). In use, it may be possible to switch between use of nitrogen in a DESI-based process or a microESI-based process and a novel ionization modality of helium assisted desorption ionization (HADI) and helium assisted spray ionization (HASI), respectively, by selecting the appropriate nebulization gas.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a schematic showing an ionization source for the mass spectrometry system according to an aspect of the present disclosure;

FIG. 2 is a schematic showing a the ionization source used for helium assisted ionization, and helium assisted desorption and ionization mass spectrometry according to an aspect of the present disclosure;

FIG. 3 is a schematic the ionization source when used for helium assisted desorption and ionization mass spectrometry according to an aspect of the present disclosure;

FIG. 4 is a schematic showing a mass spectrometry system according to an aspect of the present disclosure;

FIG. 5 is a graph (mass spectrum) showing DESI-MS spectra of 10 pmol/mm² myoglobin and hydrocortisone desorbed with 0.2% formic acid in 50% MeOH from a microscopic glass slide, with He or N₂ as nebulizing gas;

FIG. 6 is a graph showing mass spectrums for direct ESI infusion of 6×His peptide in different solvent systems, (A), (B) 0.2% formic acid in 50% MeOH:H₂O, (C), (D) 50% MeOH:H₂O and (E), (F) 200 mM ammonium bicarbonate in 50% MeOH:H₂O, nebulized by N₂ or He;

FIG. 7 is a graph (mass spectrum) showing direct detection of active pharmaceuticals under ambient conditions, including: A) Loratadine from a tablet, B) Hydrocortisone from a 1% hydrocortisone ointment, C) Acetaminophen from a tablet, wherein spectra collected with He or N₂ were scaled to the highest peak in the helium scan range, and overlaid;

FIG. 8 is a graph (mass spectrum) showing DESI-MS spectra of phospholipids in zebrafish brain applied to a microscopic glass slide analyzed by 50% ACN:DMF in positive mode, wherein spectra collected with He or N₂ were scaled to the highest peak in the helium scan range, and overlaid;

FIG. 9 is a graph (mass spectrum) showing detection of phospholipids from chicken egg yolk applied to a glass slide by DESI-MS in positive mode with 80% MeOH as desorption solvent, wherein spectra collected with He and N₂ were scaled to the highest peak in the helium scan range, and overlaid;

FIG. 10 is a chart showing a comparison between signal responses of hydrocortisone in ESI-based and DESI-based processes in different solvent systems with He compared to N₂ as nebulizing gasses;

FIG. 11 is a chart showing a comparison between ESI-based and DESI-based signal responses of equimolar theobromine and caffeine in different solvent systems with He compared to N₂ as nebulizing gasses;

FIG. 12 is a graph (mass spectrum) showing a Thermo Scientific IonMax ESI source on LTQ (linear ion trap mass spectrometer) utilizing the unmodified commercially available system of FIG. 13;

FIG. 13 is a partially fragmentary perspective view of an ESI probe and mass spectrometer inlet showing ESI spray with He as sheath gas in a system corresponding to the results shown in FIG. 12;

FIG. 14 is a graph (mass spectrum) showing the results for hydrocortisone by utilizing the unmodified commercially available Z-spray ionization source on a Waters ZQ mass spectrometer of FIG. 15; and

FIG. 15 is a partially fragmentary view of a portion of an unmodified commercially available mass spectrometer utilized to produce the results (mass spectrum) shown in FIG. 14, showing ESI spray with He as sheath gas, and a mass spectrometer inlet.

### DETAILED DESCRIPTION OF EMBODIMENTS

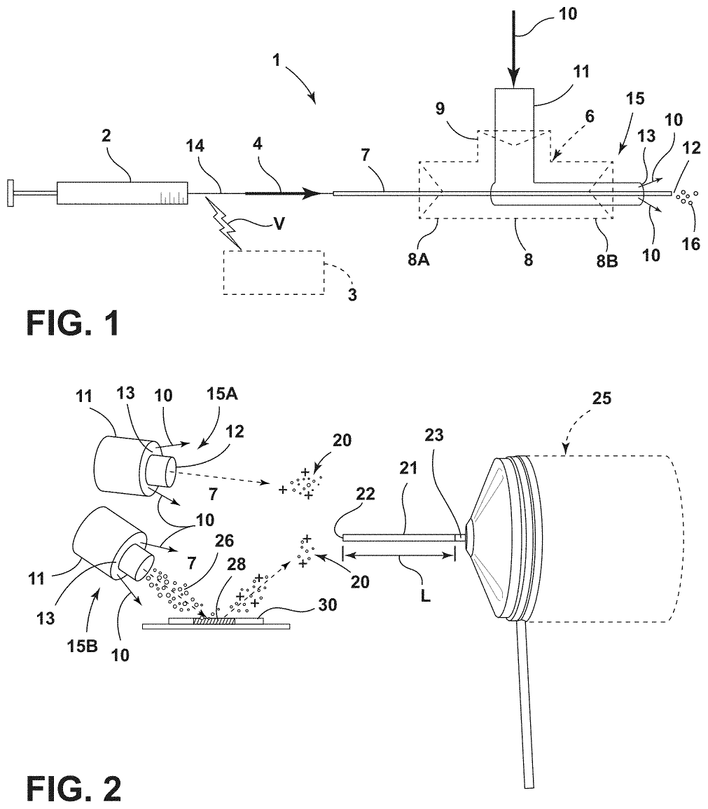

For purposes of description herein the terms “upper,” “lower,” “right,” “left,” “rear,” “front,” “vertical,” “horizontal,” and derivatives thereof are not limiting and shall relate to the device/disclosure as oriented in FIGS. 1-2. However, it is to be understood that the disclosure may assume various alternative orientations and step sequences, except where expressly specified to the contrary. It is also to be understood that the specific disclosures illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

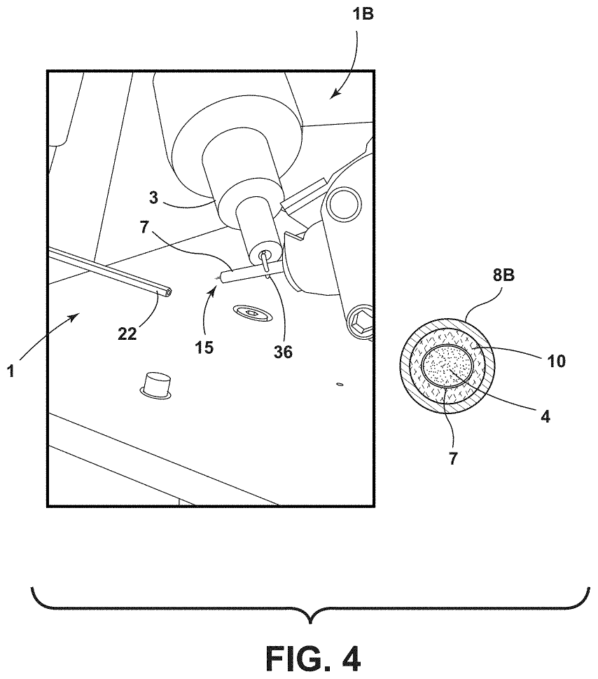

With reference to FIGS. 1-2, a mass spectrometry system 1 according to an aspect of the present disclosure includes a solvent syringe pump 2 and a voltage source 3 that supplies a voltage V to an electrically conductive (e.g. metal) needle 14. Syringe pump 2 supplies liquid solvent or sample 4 at, for example, about 1-10 μl/min, and 1-5 kV voltage. Liquid solvent or sample 4 is supplied to a T-piece 6 via a liquid capillary or conduit 7. Capillary 7 may comprise an electrically non-conductive material (e.g. fused silica), or the capillary 7 may comprise an electrically conductive material (e.g. metal). If capillary 7 is non-conductive, voltage V may be applied to needle 14 and the liquid 4 provides an electrically conductive connection. Alternatively, as shown in FIG. 4, if capillary 7 is conductive, voltage may be applied to liquid capillary 7 or gas capillary 13 using clip or connector 36 of voltage source 3. T-piece 6 includes a linear portion 8 having a first end 8A and a second end 8B. T-piece 6 further includes a transverse portion 9 and a gas conduit or capillary 11 that receives gas 10 (e.g. helium) to form ion source 15 comprising an open end 12 of capillary 7 and an open end of gas capillary 13 of gas conduit 11. Liquid droplets 16 are expelled (sprayed) from open end 12 of capillary 7, and helium gas 10 is expelled from open end 13 of gas capillary 11. Capillaries 7 and 11 may be generally coaxial, and may have generally cylindrical inner and/or outer surfaces. However, it will be understood that this is not required, and virtually any suitable configuration may be utilized.

With reference to FIG. 2, in a helium-assisted spray ionization process, liquid 7 may comprise a mixture of solvent and sample material and, according to an aspect of the present disclosure, an ion source 15A emits a mixture 20 of solvent and sample material (ions) towards an inlet 22 of a mass spectrometer 25. Alternatively, in a helium-assisted desorption ionization process according to another aspect of the present disclosure, liquid 7 may comprise solvent such that ion source 15B emits (sprays) solvent 26 towards a sample 28 disposed on a substrate 30, causing mixture 20 of solvent and sample material (ions) to be directed towards inlet 22 of mass spectrometer 25. Ionization sources 15A and 15B preferably comprise microspray ionization sources, and may comprise electrosonic spray ionization that preferably provide a high velocity (e.g. supersonic or near supersonic) jet of helium gas 10 exiting open end 13 of gas conduit 10. As discussed in more detail below, helium assisted spray ionization and helium assisted desorption ionization processes according to the present disclosure provide unique improvements relative to known processes.

Inlet 22 is formed by a tubular extension 21 having a length “L” that is sealingly connected to a conventional inlet 23 of a commercially available mass spectrometer 25. The length L may be about, for example, 5 cm. Inlet 23 may have a significantly smaller length (e.g. about 5 mm). The increased length provided by extension 21 may reduce the volume and/or velocity (mass) of air, nebulizing gas (e.g. helium), and/or other materials drawn into inlet 22. Extension 21 may also permit inlet 22 to be positioned closer to ion source 15A and/or sample 28 to thereby alter (improve) the results by controlling the materials drawn into opening 22. It will be understood that the present disclosure is not limited to an extension 21 having a specific configuration or length. Rather, extension 21 may be 5 cm or longer (e.g. 5-25 cm) or 5 cm or shorter (e.g. 1-5 cm) as required for a particular application. Also, if reduced flow (vacuum) at inlet 22 is required for a particular application, a flow restriction such as an internal fitting (not shown) may be positioned in end 23 and/or in extension 21.

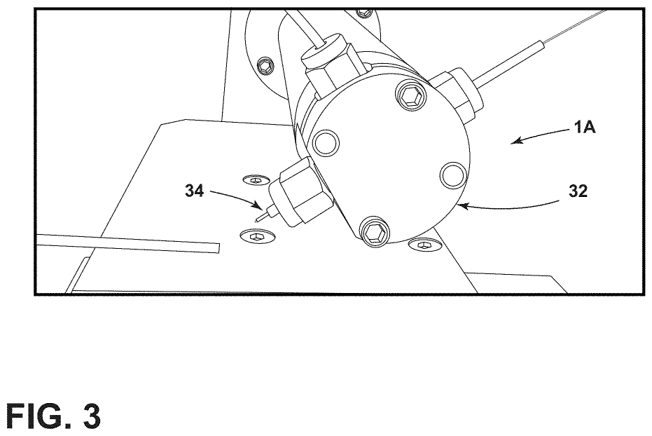

With reference to FIG. 3, a mass spectrometry system 1A according to another aspect of the disclosure may implement a 3-dimensional translational stage unit 32, for positioning of the ionization source comprising an ion source spray tip 34. The mass spectrometry system 1A may be modified to implement the helium-assisted mass spectrometry process as described herein.

With further reference to FIG. 4, the mass spectrometry system 1B, and voltage from voltage source 3 may be applied at a selected location using connector 36 (e.g. a clip) on a metal capillary that delivers He. The discharge (plasma) from ion source 15 may increase when the voltage is applied closer to the point of nebulization at ion source 15 via the metal capillary that delivers the helium. In general, the voltage may be applied to either a solvent syringe 2 (FIG. 1) or to the nebulizing capillary.

### Experimental

A mass spectrometry system 1 (FIG. 1) according to an aspect of the present disclosure may comprise Linear Trap Quadropole (LTQ) mass spectrometer (Thermo Scientific, Waltham, Mass., USA), or any other atmospheric pressure ionization mass spectrometer, which may be combined with a 3-dimensional translational stage (FIG. 3) for DESI-based analyses. An electrospray emitter and desorption sprayer includes a T-piece 6 and two pieces of coaxial fused silica capillary tubing. The outer capillary 11 (for sheath gas) may be approximately 15 mm in length (e.g. 10-20 mm in length) with an outer diameter of about 430 μm (e.g. 380-480 μm), and an inner diameter of about 320 μm (e.g. 270-370 μm). The internal capillary 7 (for solvent) may have an outer diameter of about 200 μm, and an inner diameter of about 75 μm (e.g 50-100 μm). The solvent capillary extends through the T-piece 6 and may be connected to syringe pump 2 by a fluid conduit. An extended ion sampling capillary comprising a 5 mm extension 21 may be utilized in the emitter. A stainless steel union may be electrically connectable to the source.

Chemicals

High purity nitrogen and helium (>99%) were purchased from Airgas (PA, USA). Equine muscle myoglobin, hydrocortisone, cortisone acetate, caffeine and theobromine were purchased from Sigma-Aldrich (MO, USA). 6×His was purchased from APExBio (TX, USA). Over-the-counter pharmaceutical tablets and hydrocortisone ointment (1%) were purchased from a local pharmacy. BioUltra grade ammonium bicarbonate (ABC), HPLC-MS grade methanol (MeOH), LC-MS grade formic acid (FA), 3-aminobenzoic acid ethyl ester (MS222) were purchased from Sigma-Aldrich (MO, USA). Milli-Q® water (18 MΩ cm⁻³) was obtained from a Thermo-Barnstead Water Polisher. Fused silica capillaries were purchased from Trajan Scientific (Ringwood, Australia). PTFE plates were purchased from Prosolia Inc. (IN, USA).

Sample Preparation

Sample solutions were either sprayed on the surface of substrate 30 or deposited on the surface of substrate 30 as droplets. Samples were sprayed with a pneumatically-assisted nebulizer spray made of two coaxial fused silica capillaries. The sprayer was orthogonally positioned at 2 cm above the surface of substrate 30. Nebulizing gas pressure and solvent flow rate were 40 psi and 3 μl/min, respectively, and the stage was moved at 200 μm/s, resulting in long homogenous protein lines deposited with 10±0.1 mm widths. For PTFE slides, 2 μl of solutions were pipetted on the slides and dried under vacuum for 30 minutes.

Adult zebrafish (Danio rerio) were anesthetized and euthanized in 0.03% MS222 until opercular motion ceased and fish no longer responded to a tail pinch. The brain was immediately dissected out and smeared onto a glass slide before being flash-frozen on dry ice. Brain samples were stored at −80° C. until DESI-MS analysis. Before analysis, samples were placed in a vacuum to thaw for approximately 10-15 minutes. All experimental and animal care protocols have been approved by the Institutional Animal Care and Use Committee (IACUC).

Instrumentation

For this experiment, a linear ion trap (Linear Trap Quadropole) (LTQ) mass spectrometer 25 (Thermo Scientific, Waltham, Mass., USA) was combined with a 3-dimensional translational stage (Purdue University, West Lafayette, Ind., USA) for DESI-based analyses. An extended ion sampling capillary 21 with an extension “L” of about 5 cm was purchased from Scientific Instruments Inc. An electrospray emitter and desorption sprayer was prepared from a Swagelok T-piece 6 (FIG. 1) and two pieces of coaxial fused silica capillary tubing. The outer capillary 11 (for sheath gas) was approximately 20 mm in length with an outer diameter of about 430 μm and inner diameter of about 320 μm. The internal capillary 7 (for solvent) had an outer diameter of about 220 μm, and inner diameter of about 75 μm. In this configuration, the solvent capillary extends through the T-piece 6 and is connected to a syringe pump 2 which delivers the liquid solvent 4.

DESI-MS and ESI-MS Parameters

The DESI sprayer incident angle was about 54°. The distance between the desorption sprayer and heated extended capillary and desorption spray from surface were about 4 mm and about 1 mm, respectively. ESI experiments were performed under the same conditions using the DESI sprayer, but sample solutions were directly sprayed towards the inlet 22 of heated extended capillary 21. Spray voltage V was about 4 kV, capillary temperature was set at 250° C., and capillary voltage and tube lens were optimized between about 20-40 V and about 90-175 V, respectively.

Mass spectra were collected and viewed in Xcalibur Qual Browser (2.0.7). Signal intensities were calculated as the average of three trials and error bars represent ±mean standard deviation.

Results and Discussion

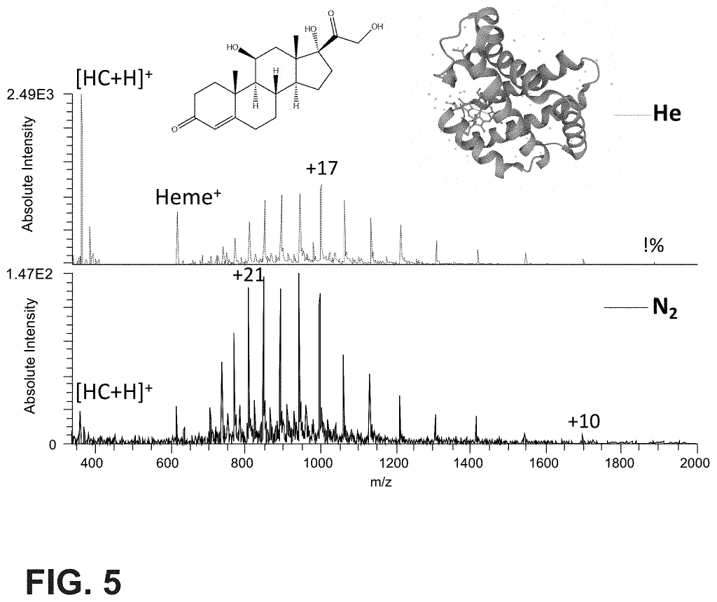

In general, an existing electrosonic spray ionization (ESSI) source may be utilized as a He plasma source by eliminating (i.e., turning off) the solvent flow, and supplying He instead of N₂ to the spray tip at high voltage. The solvent flow is turned back on for the analysis. An aspect of the present disclosure is the use of He as a nebulizing gas in a modified ESSI sprayer that may be similar to ESI sprayers previously used for DESI in order to simultaneously analyze both small molecules and polar macromolecules. FIG. 5 demonstrates that in an equimolar sample of hydrocortisone and myoglobin deposited on a microscopic glass slide, it is possible to see the highly charged apo-myoglobin by using 0.2% formic acid in 50% MeOH when using He as the nebulizing gas at a high voltage (+4 kV). Switching the nebulizing gas from N₂ to He improved the signal intensity of protonated hydrocortisone, a steroid, more than 20 fold, while still allowing detection of multiply charged apo-myoglobin charge states and increasing its signal intensity by more than 5 times. Thus, using He as a DESI nebulizing gas does not negatively affect the electrospray ionization processes.

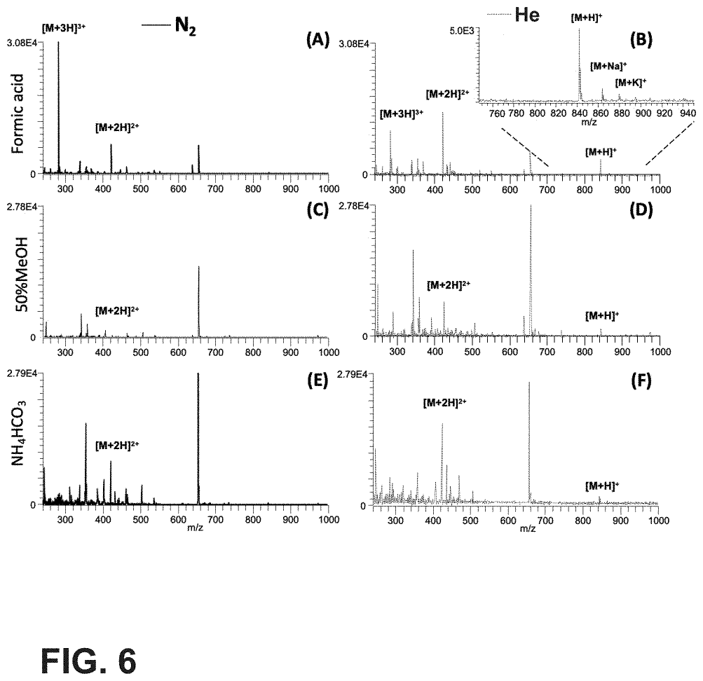

FIG. 6 shows the results when 100 nM 6×His peptide in three different solvent systems were analyzed by direct ESSI infusion and changes in signal intensity of the three charge states of 6×His were compared upon using He instead of N₂ as the nebulizing gas in a system according to FIGS. 1-2.

As shown in FIG. 6, singly charged 6×His at m/z 841 showed the highest relative improvement up to 18 times upon switching to He from N₂ in all solvent systems, while the signal intensity of +2 charge state at m/z 421 and +3 charge state at m/z 281 only increase in 50% MeOH:H₂O approximately 10 and 3 times, respectively.

The relative improvement of each charge state in three solvent systems when utilizing He rather than N₂ is shown in Table 1.

TABLE 1
The relative improvement in absolute signal intensity of each charge
state of 6xHis peptide by switching to He from N₂ in three solvent system.
Relative improvement in absolute signal intensity (He vs N₂)

| | m/z (charge state) | | |
|---|---|---|---|
| Solvent system | 841 (+1) | 421 (+2) | 281 (+3) |
| 0.2% Formic acid in 50% MeOH | 15.17 | 1.15 | 1.48 |
| 50% MeOH | 18.22 | 10.47 | 3.42 |
| 200 mM ammonium bicarbonate | 3.21 | 0.96 | 1.51 |
| in 50% MeOH | | | |

Although not wishing to be bound by a specific theory or explanation, the differences between signal responses of charge state 1 compared to charge states 2 and 3 suggest that the corona discharge generated by He under high voltage of the electrospray (+4 kV) may be increasing signal intensity of singly charged peptide through proton transfer mechanism similar to DC generated plasma, such as DART, while electrospray ionization resulting in formation of multiply charged peaks (charge states 2 and 3) may also be occurring simultaneously as well. However, it will be understood that changes in plasma intensity do not necessarily cause changes in the results (signal strength) in every case.

To investigate the application of HADI, direct analysis of multiple samples under ambient conditions was investigated. Direct detection of active ingredients under ambient conditions, such as detection of pharmaceuticals from tablets and creams, has been a reported application of ambient ionization techniques such as DART and DESI-MS. Due to the nature of the extraction/desorption step in DESI, it may be beneficial (in some cases) to change the solvent composition to increase signal intensity. Some reports suggest that DESI-MS may perform poorly for non-polar compounds such as hydrocortisone when compared to DAPCI.

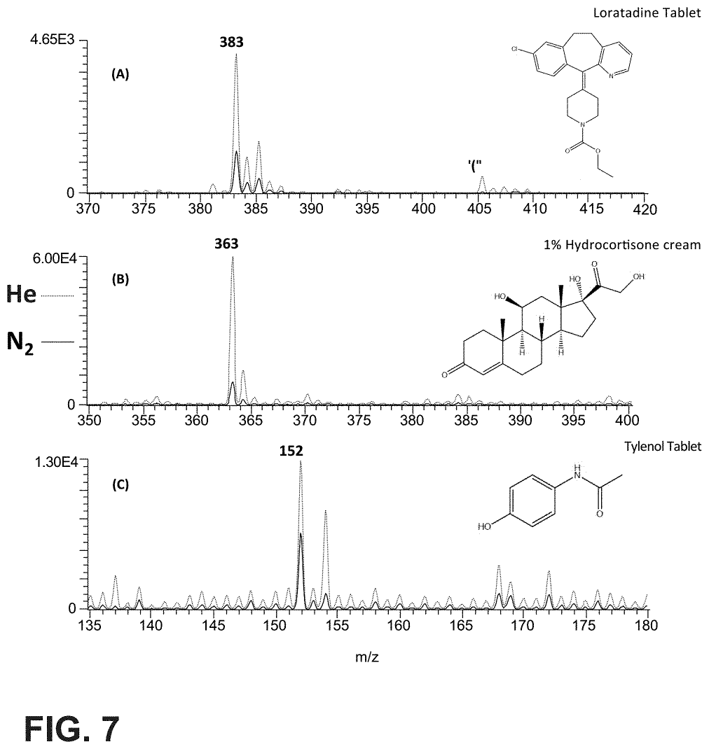

FIG. 7 shows direct detection (mass spectrum) of pharmaceuticals under ambient conditions, including A) Loratadine from a tablet; B) Hydrocortisone from a 1% hydrocortisone ointment; and C) Tylenol® from a tablet. The results shown in FIG. 7 demonstrate that using He as nebulizing gas (e.g. in a HADI process according to an aspect of the present disclosure) can increase the DESI-MS signal intensity of several active ingredients directly detected from a tablet or cream by using MeOH:H₂O as desorption solvent and no additives. For example, hydrocortisone was easily detected from 1% hydrocortisone cream using He and 90% MeOH, with a 10-fold increase in signal intensity compared to a DESI using N₂ as a nebulizing gas. Loratadine from an allergy relief tablet and acetaminophen from a tablet were also directly detected by DESI-MS using 80% MeOH as solvent. Utilizing He as the nebulizing gas increased the absolute signal intensity of these active ingredients by approximately 4 and 3 times, respectively, compared to a DESI process which uses N₂ as the nebulizing gas.

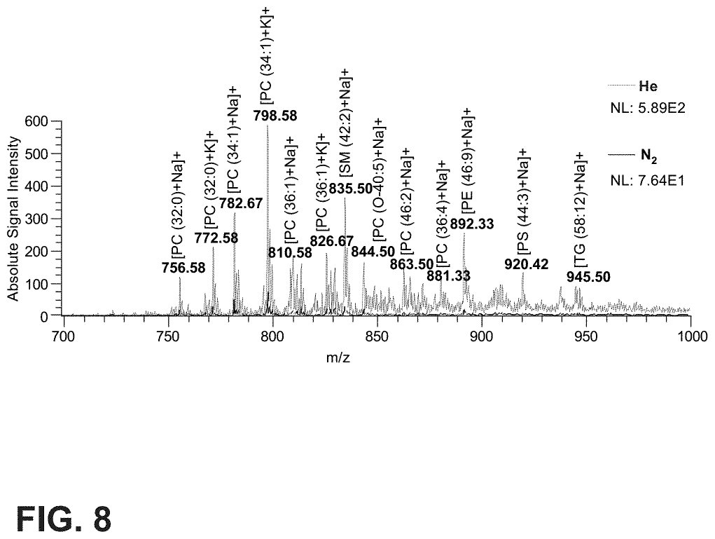

With reference to FIG. 8, this method was also tested for ambient analysis of more complex mixtures. FIG. 8 shows direct detection (mass spectrum) and improvement of multiple phospholipids from zebrafish brain in positive mode using 50% ACN:DMF as the desorption solvent and He as the nebulizing gas. The majority of peaks corresponded to phosphatidylcholines (PC) as sodium or potassium adducts in the m/z 750-850 range. Other phospholipid types were also detected as sodium adducts including sphingomyelin (SM), phosphatidic acid (PA), phosphatidylethanolamine (PE), phosphatidylinositol (PI), phosphatidylserine (PS), and triglyceride (TG). Peaks were tentatively identified from available literature, LipidBlast, and LipidMaps libraries.

Comparison of the absolute signal intensity of m/z 798, tentatively identified as [PC (34:1)+K]⁺, increased by approximately 8 times when He was used as the nebulizing gas. This effect does not appear to be specific to certain phospholipid types since the signal for all lipids were increased with the use of He.

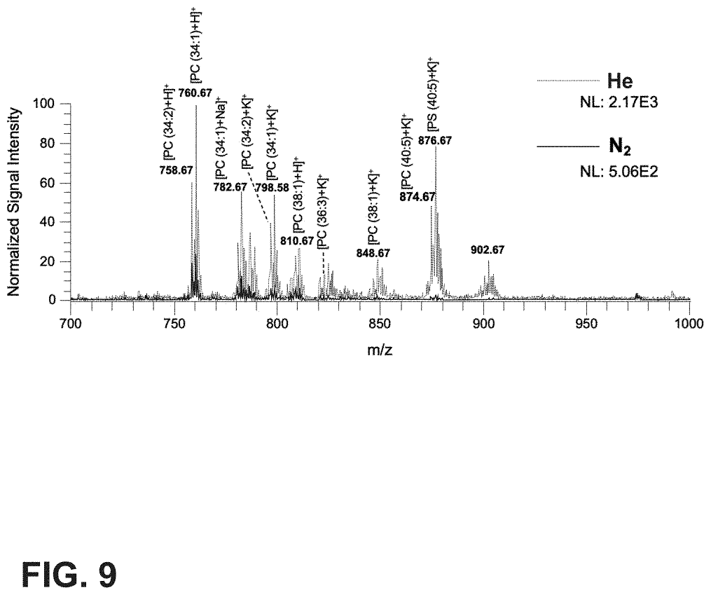

FIG. 9 shows detection (mass spectrum) of phospholipids from chicken egg yolk on a glass slide with 80% MeOH, where signal intensity of peaks at m/z 760 which corresponds to [PC (34:1)+H]⁺ and m/z 782 which corresponds to [PC (34:1)+Na]⁺ increased by approximately 4 times.

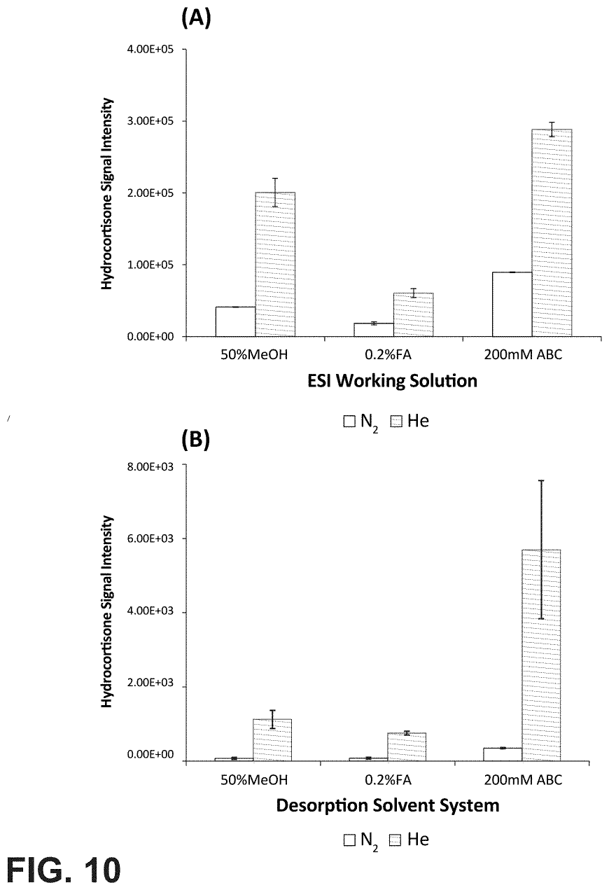

The purpose of the testing of FIG. 10 was to investigate whether the increase in signal intensity of these compounds (utilizing a system according to FIGS. 1 and 2) is from a desorption effect or from changes in the ionization mechanism with He, 100 nM hydrocortisone in 50% MeOH:H₂O, 200 mM ammonium bicarbonate in 50% MeOH:H₂O and 0.2% formic acid in 50% MeOH:H₂O was used for direct ESI analysis and the signal response was compared to 20 pmol/mm² hydrocortisone desorbed from a microscopic glass slide with the same solvent systems while all other parameters were maintained the same. The signal response in ESI-based and DESI-based processes generally followed the same trend, although the extent of improvement using He was more significant in DESI-based experiments.

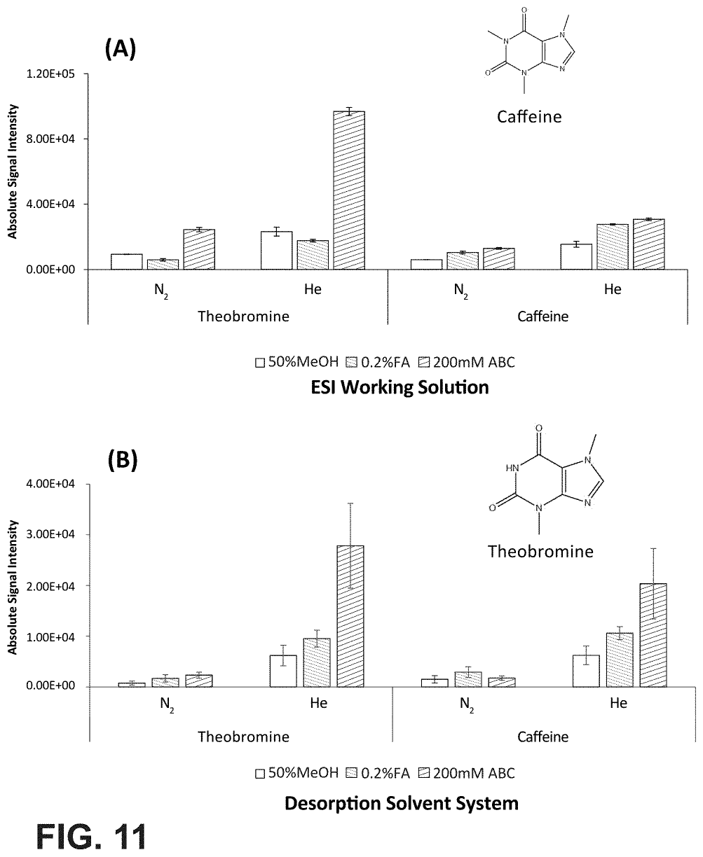

With reference to FIG. 11, in order to further compare multiple analyte ionization responses, equimolar concentrations of 100 nM theobromine and caffeine in similar solvent systems were compared to 20 pmol/mm² spots of theobromine and caffeine on PTFE sample substrates.

Similar to hydrocortisone, DESI-based and ESI-based responses of equimolar theobromine and caffeine followed a similar trend when He is used as the nebulizing gas rather than N₂. Although not wishing to be bound by a specific theory or explanation, the data suggest that improvements in the ionization process may be happening in both ESI-based and DESI-based experiments.

Although improvement is obtained in both DESI-based and ESI-based processes for sampled analytes, the greater improvement observed in DESI-based processes suggests that He may have a beneficial effect on the desorption process as well. This is supported by the observation of a smaller DESI-based footprint with He at 140 psi compared to N₂ at 140 psi, with less splashing observed around the footprint when Rhodamine G lines were desorbed from a microscopic glass slide (not shown). This observation may imply that a more focused and energetic spray is directed towards the surface when He is used as the nebulizing gas. This shift in desorption behavior may explain the large increase in signal intensity of analytes, regardless of the surface type (glass, PTFE, or tissue). According to previous droplet dynamic studies of DESI-MS, when fast-moving desorption droplets collide with atmospheric gasses, the droplets are slowed by aerodynamic drag forces due to their interaction with surrounding gas molecules. He molecules are smaller and have less mass than N₂ molecules, and He tends to behave more similarly to an ideal gas. Thus, although not wishing to be bound by a specific explanation or possibility, a He spray may yield a more energetic desorption spray compared to a standard DESI spray with N₂ and, as a result, provides a better desorption yield. Based on the ESI-based results, it is also possible that He has an additional beneficial effect on ionization.

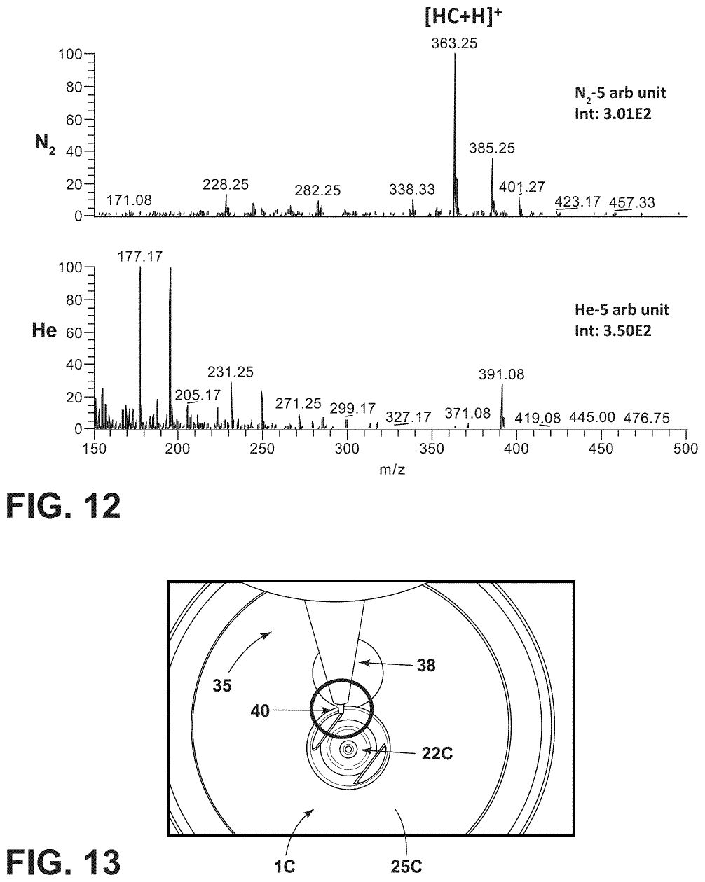

With further reference to FIGS. 12 and 13, an unmodified commercially available mass spectrometry system 1C (FIG. 13) was tested using He as the nebulizing gas, which produced the results shown in FIG. 12. The unmodified system 1C includes a Thermo Scientific™ Ion Max™ source 35, and an ESI probe 38. The unmodified system 1C produced ESI spray 40 with He as the sheath gas. Mass spectrometer 25C is a thermal scientific LTQ linear ion trap mass spectrometer having an inlet 22C. The results (FIG. 12) show no improvements when using He as a nebulizing gas in unmodified system 1C.

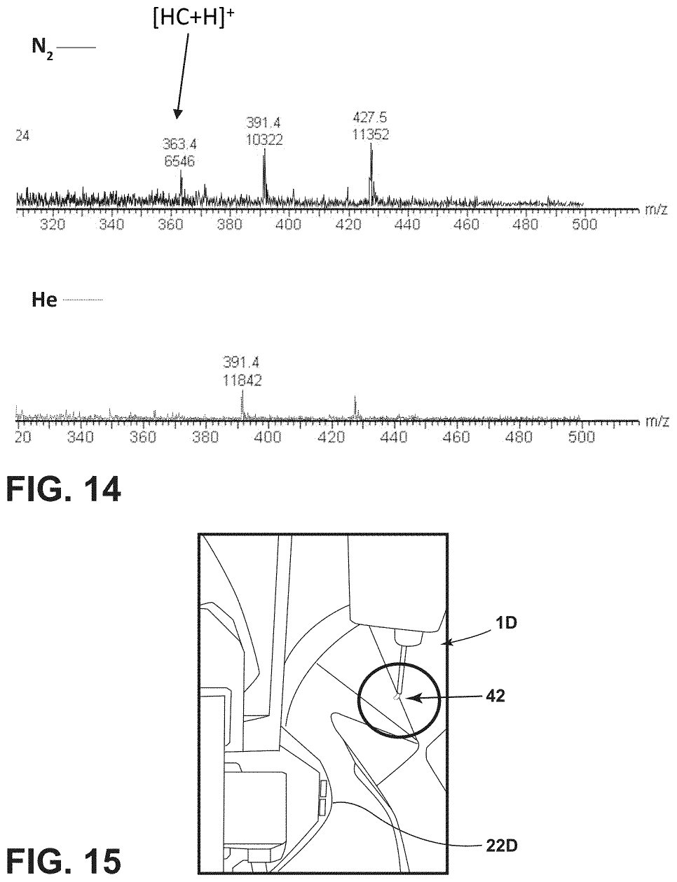

FIG. 14 shows the results for hydrocortisone in an unmodified mass spectrometer 1D forming an ESI spray 42 with He as a sheath gas. The mass spectrometer 1D is a commercially available Waters ZQ mass spectrometer having an inlet 22D (available from Waters Corporation, Millford, Mass., USA). As shown in FIG. 14, He did not provide improved results when used in an unmodified system 1D.

A method according an aspect of the present disclosure may be utilized in Helium Assisted Desorption and Ionization (HADI) that uses helium as nebulizing gas in desorption electrospray ionization (DESI), and Helium Assisted Spray Ionization (HASI) when helium is used with micro electrospray ionization source similar to ESSI. In a method according to aspects of the present disclosure, analyte ion signals my be improved, and the deleterious effects of ions created by the breakdown products of atmospheric gasses and helium may be suppressed or reduced. While ion intensities for both protein and small molecules may increase with helium addition, less-polar small molecules may be improved to a larger extent. Helium may also produce a smaller desorption footprint than nitrogen, thereby providing benefits for chemical microscopy applications by DESI-MS.

An electrospray emitter and desorption sprayer may be prepared from a Swagelok T-piece and two pieces of coaxial capillary tubing. The solvent capillary may be extended through the T-piece and may be connected to a syringe pump which is configured to deliver the solvent. A LTQ mass spectrometer with an extended ion sampling capillary with a 5 cm extension may be combined with a 3-dimensional translational stage for DESI and ESI analyses. High purity nitrogen and helium (>99%) were used as nebulizing gas. In testing, high purity myoglobin, hydrocortisone, cortisone acetate, caffeine and theobromine were used as standard samples. Over-the-counter pharmaceutical tablets of Loratadine and Tylenol and hydrocortisone ointment (1%) were used for ambient analysis experiments. Adult zebrafish brain smears and egg yolk smears were used for lipid analysis.

Testing demonstrated that when using He as nebulizing gas in the ionization spray for analyzing an equimolar sample of hydrocortisone and myoglobin deposited on a glass slide, the signal intensity of protonated hydrocortisone increased more than 20-fold, while signal intensity of multiply charged apo-myoglobin also increased by 5. HADI increased the signal intensity of several active ingredients directly detected from the tablet or cream by MeOH:H₂O as desorption solvent without any additives such as formic acid. Hydrocortisone was easily detected from 1% hydrocortisone cream using He, with a 10-fold increase in signal intensity compared to standard N₂. Signal intensities for Loratadine and Tylenol when detected directly from the tablets increased by approximately 4 and 3 times, respectively. Detection of phospholipids from zebrafish brain in positive mode using 50% ACN:DMF as the desorption solvent was also improved up to 8 times for the majority of peaks corresponded to phosphatidylcholines (PC) as sodium or potassium adducts.

In testing according to aspects of the present disclosure, the detection of phospholipids from chicken egg yolk in positive mode with 80% MeOH as desorption solvent also improved dramatically. To investigate whether the increase in signal intensity of these compounds is due improved desorption when using helium, or changes in the ionization mechanism, helium as nebulizing gas was used in both DESI and ESI for a range of small molecules including caffeine, theobromine, and hydrocortisone with 50% MeOH:H₂O or solvent system with either formic acid or ammonium bicarbonate added. The signal response in ESI and DESI generally followed the same trend, although the extent of improvement upon switching to He was more significant in the DESI experiments. This indicates that both desorption and ionization processes may be positively influenced when helium is used as nebulizing gas. An additional potential benefit is smaller DESI desorption footprint, with potential to improve chemical microscopy by DESI-MS.

Thus, Helium-assisted desorption ionization (HADI) and helium-assisted spray ionization (HASI) according to aspects of the present disclosure may increase signal intensity compared to conventional DESI and ESI.

The present disclosure describes a novel method for improving DESI-MS and ESI-MS analysis of a wide variety of samples under different degrees of ambient conditions. The use of He gas in DESI-based and ESI-based systems and processes is particularly useful for simultaneous detection of small non-polar compounds such as steroids and large polar analytes like proteins. The addition of ammonium bicarbonate and formic acid as solution-phase additives can be beneficial for the analysis of certain compounds such as proteins. These solution-phase additives can enhance the spectral quality of certain analytes, and when combined with He as a nebulizing gas, can expand the applicability of this technique for simultaneous sampling of small non-polar and polar compounds and large molecules as well.

It will be understood that DESI-based and ESI-based processes according to the present disclosure typically involve more than simply substituting He for N₂ in existing DESI and ESI processes and/or systems. Rather, as described above, various adjustments to the process parameters and/or systems may be required to provide improved results when using He as the nebulizing gas. Also, although use of pure He as a nebulizing gas is presently preferred, it will be understood that the present disclosure and claims are not limited to pure He unless pure He is expressly recited.

Compared to known commercial electrospray ionization sources, devices and processes according to the present disclosure may include one or more differences (features) in any combination:

1. The use of helium. This may, by itself, contribute to improved (greater) analyte ion signals compared to use of nitrogen gas. This may, by itself, suppress deleterious effects of ions created by the breakdown products of atmospheric gasses and helium.

2. A lower liquid (e.g. solvent) flow rate may, by itself, contribute to improved (greater) analyte ion signals. The liquid flow rate may be in the microliter per minute regime in accordance with an aspect of the present disclosure. Liquid flow rates in devices and/or processes according to the present disclosure may be separately optimized for nebulization assisted ionization.

3. A higher gas flow rate. For example, a higher linear gas velocity compared to commercial sources. This, may, optionally, be provided by adjusting the gap between the inner liquid capillary and the annular exterior gas capillary. For example, the cross sectional area of the gap may be decreased in order to increase the velocity of the helium gas for a given mass flow rate. Alternatively, the cross sectional area of the gap may be decreased in order to increase the velocity of the helium gas and to simultaneously reduce the mass flow rate of the helium gas. Still further, the pressure of helium gas may be adjusted to increase or decrease the velocity and/or mass flow rate of the helium gas.

4. An extended ion inlet capillary.

Each feature noted above may independently contribute to the improved results (e.g. greater signal strength) described herein. However, any combination of these features may also be utilized.

Additionally, unless otherwise specified, it is to be understood that discussion of a particular feature or component extending in or along a given direction or the like does not mean that the feature or component follows a straight line or axis in such a direction or that it only extends in such direction or on such a plane without other directional components or deviations, unless otherwise specified.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A method of ionizing a liquid for use in mass spectrometry, the method comprising:
causing a liquid comprising at least a solvent to flow through a first capillary in a downstream direction;
causing helium nebulizing gas to flow in a downstream direction through a space formed between the first capillary and a second capillary that surrounds at least a portion of the first capillary, wherein the first and second capillaries have open ends that are adjacent one another to form, in use, an ion source that emits electrospray droplets;
applying voltage to the liquid at a location that is upstream from the ion source;
causing sample material to enter an inlet of a mass spectrometer whereby the mass spectrometer is able to provide a signal intensity at a plurality of mass-to-charge ratios (m/z); and
adjusting one or more process parameters to provide increased signal intensity for at least one m/z relative to a signal intensity produced utilizing nitrogen nebulizing gas.

2. The method of claim 1, wherein:
the voltage is applied to the liquid at a location that is sufficiently far upstream from the ion source so as to prevent discharge at the ion source sufficient to substantially alter the signal intensity.

3. The method of claim 1, including:
adjusting a pressure differential at the inlet of a mass spectrometer to provide increased signal intensity.

4. The method of claim 3, including:
adjusting a pressure differential at the inlet of a mass spectrometer to provide increased signal intensity.

5. The method of claim 3, wherein:
the inlet of a mass spectrometer comprises a tube; and including:
increasing a length of the tube to reduce a vacuum at the inlet of a mass spectrometer to provide increased signal intensity.

6. The method of claim 1, including:
adjusting at least one of a size and shape of at least one of the first capillary and the second capillary to increase signal intensity for at least one m/z.

7. The method of claim 1, including:
adjusting a mass flow rate of the helium gas to increase signal intensity for at least one m/z.

8. The method of claim 1, wherein:
a syringe pump having an electrically conductive needle is utilized to cause the liquid to flow through the first capillary; and
the voltage is applied to the conductive needle.

9. The method of claim 8, wherein:
the first capillary comprises fused silica having an internal passageway that is fluidly connected to the electrically conductive needle; and including:
causing liquid to flow through the electrically conductive needle and the internal passageway of the fused silica.

10. The method of claim 1, wherein:
the second capillary comprises an electrically conductive material;
applying a voltage to a liquid includes applying a voltage to the second capillary.

11. The method of claim 1, including:
adjusting a mass flow rate of the helium flowing through the second capillary to determine a mass flow rate of the helium at which an optimum signal intensity is generated by the mass spectrometer.

12. The method of claim 1, including:
directing the electrospray droplets at a sample surface to extract ions from the sample surface.
